(19) United States
(12) Patent Application Publication
(10) Pub. No.: US 2007/0157970 A1
(43) Pub. Date: Jul. 12, 2007

(54) Check valve for fluid

(75) Inventors: Alex Horng, Kaohsiung (TW); Tso-Kuo Yin, Kaohsiung Hsien (TW)

Correspondence Address: BIRCH STEWART KOLASCH & BIRCH, PO BOX 747, FALLS CHURCH, VA, 22040-0747, US

(73) Assignee: Sunonwealth Electric Machine Industry Co., Ltd.

(21) Appl. No.: 11/329,249

(22) Filed: Jan. 11, 2006

(51) Int. Cl. F16K 15/14

(52) U.S. Cl. 137/512.15

(57) ABSTRACT

A check valve for fluid includes a tubular member, a cap, and a flexible membrane. The tubular member includes a coupling section and an inlet. The coupling section of the tubular member includes a valve portion, an end face, and a positioning rod. The cap includes a coupling section coupled with the coupling section of the tubular member, an outlet aligned with the valve port, and a positioning rod on the outlet of the cap. The flexible membrane includes a positioning portion securely sandwiched between the positioning rods. The flexible membrane further includes a sealing circumference. When fluid flows in a reverse direction, the flexible membrane seals the valve port and the sealing circumference of the flexible membrane is supported by the end face of the tubular member. When the fluid flows in a forward direction, the flexible membrane is bent to allow the fluid to flow from the inlet to the outlet.

### BACKGROUND OF THE INVENTION

1. Field of the Invention

The present invention relates to a check valve for fluid, and more particularly to a check valve having a reinforcing structure for a flexible membrane.

2. Description of Related Art

FIG. 1 of the drawings illustrates a conventional check valve 91 for fluid. The check valve 91 is mounted between an inlet pipe 92 and an outlet pipe 93 and comprises a flexible membrane 94 having a fixed end 941 and a movable end 942. The fixed end 941 of the flexible membrane 94 is fixed to an end face of the inlet pipe 92. When the fluid flows from the inlet pipe 92 toward the outlet pipe 93, the movable end 942 of the flexible membrane 94 is pushed away from the end face of the inlet pipe 92, allowing fluid to flow to the outlet pipe 93. On the other hand, when the fluid flows from the outlet pipe 93 toward the inlet pipe 92, the movable end 942 of the flexible membrane 94 is pushed by the fluid to press against the end face of the inlet pipe 92. In other words, the end of the inlet pipe 92 is blocked by the flexible membrane 94, preventing the fluid from flowing from the outlet pipe 93 to the inlet pipe 92.

However, the flexible membrane 94 must directly face the end face of the inlet pipe 92 to effectively seal the end of the inlet pipe 92. In other words, the sealing effect could not be obtained and leakage occurs when the flexible membrane 94 is shifted. Further, the flexible membrane 94 could not reliably press against the end face of the inlet pipe 92 when the pressure of the fluid is too high and thus causes deformation of the movable end 942 of the flexible membrane 92 into the end of the inlet pipe 92. A counter flow of the fluid occurs accordingly. On the other hand, if the pressure difference of the fluid between the inlet pipe 92 and the check valve 91 is unsuitable for maintaining the flexible membrane 94 against the end face of the inlet pipe 92, leakage of fluid through the membrane 94 or a counter flow in the inlet pipe 92 occurs.

Taiwan Utility Model Publication No. M269383 proposes a check valve to solve the above problems. The check valve comprises a coupler, a cap, a plug, and a net device. The coupler is tubular and includes a positioning/partitioning plate on a bottom end thereof. The positioning/partitioning plate includes a central limiting hole, a plurality of inlet holes surrounding the central limiting hole, and an engaging portion extending from the positioning/partitioning plate. A top portion of the cap extends upward to form a chamber and engages with an engaging portion of the positioning/partitioning plate. The plug is extended into and used to seal a through-hole delimiting the chamber. A column extends upward from top of the plug and extends into the central limiting hole of the positioning/partitioning plate. A push rod extends downward from a bottom face of the plug. The push rod extends out of the chamber via the through-hole. The net device includes a plurality of inlets in a cylindrical wall thereof, with a flange formed on an outer circumference of the cylindrical wall for securely engaging with an engaging groove of the cap. The net device further includes a bottom wall from which a tube extends upward. The tube includes a hole into which the push rod extends. An elastic element is mounted around the push rod and retained in place by a retainer such as a C-clip. The elastic element biases the push rod downward, carrying the plug on top of the push rod to move downward for sealing the through-hole in the bottom wall delimiting the chamber, thereby preventing counter flow of fluid. However, such a check valve is very complicated. Further, the check valve can only be used for fluid with a pressure high enough to overcome the elastic element that biases the plug.

A personal computer or a notebook computer uses a fluid-cooling type heat-dissipating module (not shown) comprising a fluid pump (not shown) which dispenses a lower fluid pressure for driving a fluid (the coolant) in heat-dissipating an object such as a central processing unit chip. The heat-dissipating module includes a check valve (not shown) to avoid counter flow of the fluid. Thus, the check valve in FIG. 1 can be used in the heat-dissipating module whereas the check valve disclosed in Taiwan Utility Model Publication No. M269383 is unsuitable for use in the heat-dissipating module. However, leakage and counter flow of the check valve in FIG. 1 and complicated structure and uneasy miniaturization of the check valve disclosed in Taiwan Utility Model Publication No. M269383 are problems that must be overcome.

### OBJECTS OF THE INVENTION

An object of the present invention is to provide a check valve with improved sealing reliability.

Another object of the present invention is to provide a check valve with improved positioning reliability.

A further object of the present invention is to provide a check valve with a simple structure to provide a compact check valve.

Still another object of the present invention is to provide a check valve that can be easily and quickly assembled.

### SUMMARY OF THE INVENTION

A check valve for fluid in accordance with the present invention comprises a tubular member, a cap, and a flexible membrane. The tubular member comprises a coupling section and an inlet. The coupling section of the tubular member comprises a valve portion, an end face, and a positioning rod. The cap comprises a coupling section for coupling with the coupling section of the tubular member. The cap further comprises an outlet aligned with the valve port, with a positioning rod provided on the outlet of the cap. The flexible membrane comprises a positioning portion securely sandwiched between the positioning rod of the tubular member and the positioning rod of the cap. The flexible membrane further comprises a sealing circumference.

When fluid flows in a counter direction, the flexible membrane seals the valve port and the sealing circumference of the flexible membrane is supported by the end face of the tubular member. When the fluid flows in a forward direction, the flexible membrane is bent to allow the fluid to flow from the inlet to the outlet.

Preferably, diameters of the coupling section and the outlet of the cap are greater than that of the valve port of the tubular member, and the end face of the tubular member is located inside the coupling section of the cap.

Preferably, the positioning rod of the tubular member extends across the valve port. The positioning rod of the cap extends across the outlet and is aligned with the positioning rod of the tubular member for sandwiching the positioning portion of the flexible membrane.

In an alternative embodiment, the positioning rod of the tubular member extends across the valve port, and the positioning rod of the cap extends across the outlet and extends in a direction orthogonal to the positioning rod of the tubular member for sandwiching the positioning portion in a center of the flexible membrane.

Preferably, the coupling section of the tubular member is a stepped portion for coupling with the coupling section of the cap.

Preferably, the coupling section of the tubular member comprises an annular groove. A sealing washer is mounted in the annular groove for preventing leakage between the coupling section of the tubular member and the coupling section of the cap.

Preferably, the coupling section of the tubular member comprises an engaging portion and the coupling section of the cap comprises an engaging portion for engaging with the engaging portion of the tubular member while locating the positioning rod of the cap relative to the positioning rod of the tubular member.

Preferably, one of the engaging portions is a protrusion and the other engaging portion is a recession.

Other objects, advantages and novel features of this invention will become more apparent from the following detailed description when taken in conjunction with the accompanying drawings.

### BRIEF DESCRIPTION OF THE DRAWINGS

FIG. 1 is a sectional view of a conventional check-valve for fluid;

FIG. 2 is an exploded perspective view of a first embodiment of a check valve for fluid in accordance with the present invention;

FIG. 3 is a sectional view of the check valve in FIG. 2;

FIG. 4 is a view similar to FIG. 3, illustrating counter flow of fluid;

FIG. 5 is a view similar to FIG. 3, illustrating forward flow of fluid; and

FIG. 6 is an exploded view of a second embodiment of the check valve in accordance with the present invention.

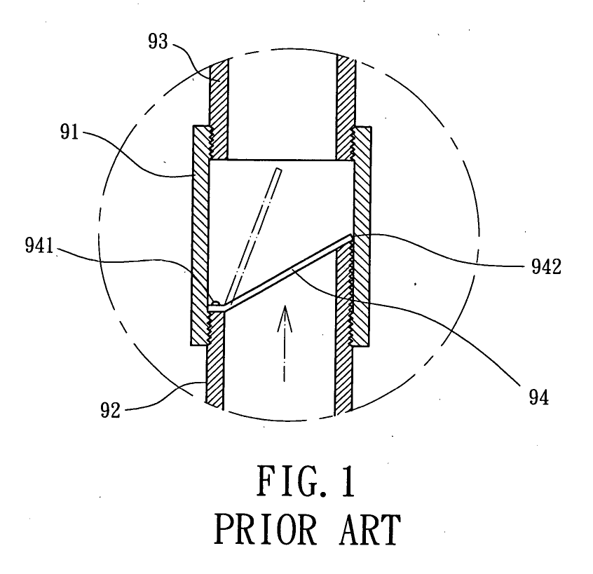

### DETAILED DESCRIPTION OF THE PREFERRED EMBODIMENTS

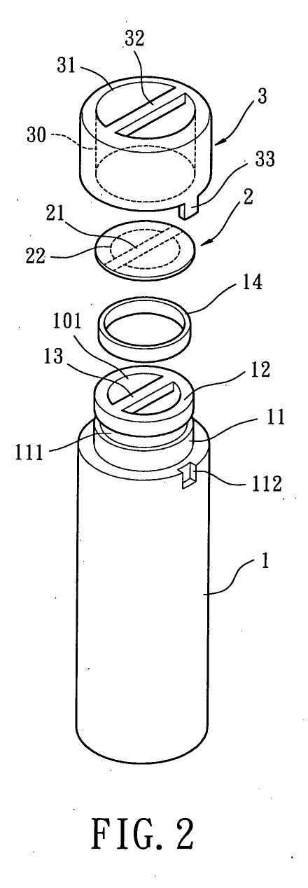

Referring to FIG. 2, a first embodiment of a check valve in accordance with the present invention comprises a tubular member 1, a flexible membrane 2, and a cap 3. The check valve allows fluid to flow in one direction (forward flow) and prevents the fluid to flow in the counter direction (counter flow). The check valve can be mounted on a pipeline of a fluid-cooling type heat-dissipating module for a personal computer or a notebook computer for controlling flow of the fluid for heat-dissipating purposes. The check valve can be used with other fluid mechanisms and operated in a similar way as disclosed above.

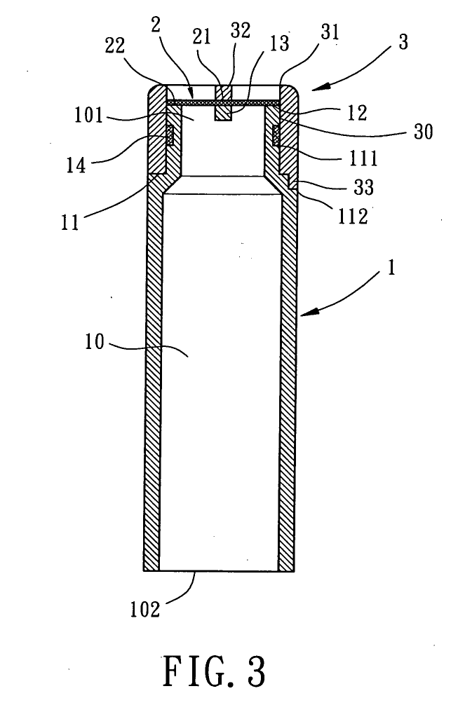

Referring to FIGS. 2 and 3, the tubular member 1 comprises a passageway 10, a coupling section 11 provided with an end face 12, a positioning rod 13, and a sealing washer 14. The passageway 10 extends throughout the tubular member 1 and includes a valve port 101 adjacent to the coupling section 11 and an inlet 102 in the inlet end of the tubular member 1. The coupling section 11 is preferably a stepped portion and comprises an annular groove 111 for receiving at least one portion of the sealing washer 14, and an engaging portion 112. The engaging portion 112 may be constructed from a recession or a protrusion. In this embodiment, the engaging portion 112 is a recession. The positioning rod 13 extends across the valve port 101, with two ends of the positioning rod 13 fixed to a circumference delimiting the valve port 101. The end face 12 is an end face of the tubular member 1 adjacent to the coupling section 11 and supports the flexible membrane 2.

Still referring to FIGS. 2 and 3, the flexible membrane 2 is made of soft material such as plastics, rubber, or waterproof cloth. The flexible membrane 2 can be pushed by fluid to turn from a flat, sealing state into a bent, open state. The flexible membrane 2 includes a positioning portion 21 and a sealing circumference 22. The positioning portion 21 is aligned with and retained in place by the positioning rod 13 of the tubular member 1. The sealing circumference 22 of the flexible membrane 2 is aligned with and supported by the end face 12 of the tubular member 1.

Still referring to FIGS. 2 and 3, the cap 3 is a substantially hollow cylindrical member and comprises a coupling section 30, an outlet 31, a positioning rod 32, and an engaging portion 33. The coupling section 30 formed in the cap 3 is coupled with the coupling section 11 of the tubular member 1. The outlet 31 of the cap 3 is in an outlet end of the cap 3. Diameters of the coupling section 30 and the outlet 31 of the cap 3 are greater than that of the valve port 101 of the tubular member 1, with the end face 12 of the tubular member 1 located inside the coupling section 30 of the cap 3. The positioning rod 32 extends across the outlet 31, with two ends of the positioning rod 32 fixed to a circumference delimiting the outlet 31. The positioning rod 32 of the cap 3 is superimposed on the positioning portion 21 of the flexible membrane 2, thereby securely sandwiching the positioning portion 21 of the flexible membrane 2 between the positioning rod 32 of the cap 3 and the positioning rod 13 of the tubular member 1. The engaging portion 33 may be a protrusion or recession. In this embodiment, the engaging portion 33 is a protrusion engaged in the recession 112 of the tubular member 1. This allows the tubular member 1 and the cap 3 to be easily and quickly engaged. Further, positions of the engaging portions 112 and 33 are so arranged that the positioning rod 32 of the cap 3 is located in a desired place relative to the positioning rod 13 of the cap 3.

Still referring to FIG. 3, in assembly, the flexible membrane 2 is placed on the end face 12 and lies on the positioning rod 13. The cap 3 is then engaged with the tubular member 1 by engaging the coupling section 30 of the cap 3 with the coupling section 11 of the tubular member 1, with the engaging portion 33 of the cap 3 rapidly and quickly aligned and engaged with the engaging portion 112 of the tubular member 1, and with the sealing washer 14 providing a sealing effect. The check valve in accordance with the present invention has a simple structure and allows easy and rapid assembling. A compact check valve is thus provided. After assembly, the positioning portion 21 of the flexible membrane 2 is securely sandwiched between the positioning rod 13 of the tubular member 1 and the positioning rod 32 of the cap 3. Undesired displacement of the flexible membrane 2 is avoided. The sealing circumference 22 of the flexible membrane 2 is tightly connected with and supported by the end face 12 of the tubular member 1. Except for the positioning portion 21, the flexible membrane 2 can be pushed and moved by the fluid toward the outlet 31 and thus bent. Namely, the flexible membrane 2 can be bent by the fluid when desired, with the positioning rod 32 of the cap 3 providing a positioning effect.

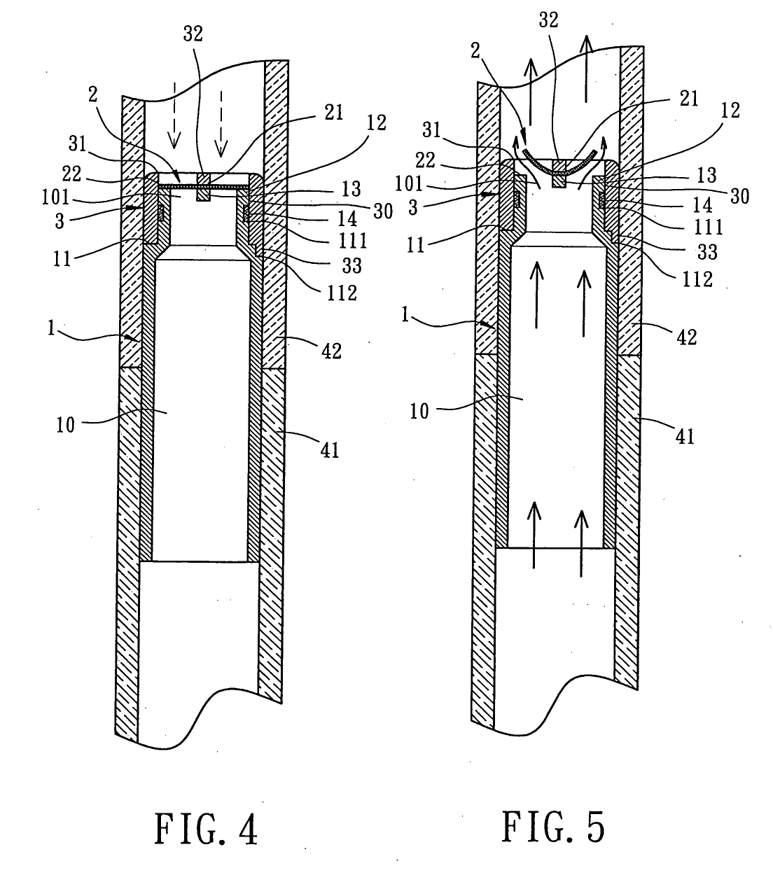

Referring to FIG. 4, the check valve 1 can be mounted in a coupling area between an inlet pipe 41 and an outlet pipe 42. In a case that a fluid (such as water or other coolant for heat-dissipating purposes) flows from the outlet pipe 42 toward the inlet pipe 41 (counter flow), the sealing circumference 22 of the flexible membrane 2 remains in intimate contact with the end face 12 of the tubular member 1, preventing the fluid from entering the inlet pipe 41. The positioning rods 13 and 32 and the positioning portion 21 of the flexible membrane 2 provide a supporting force sufficient to maintain the sealing circumference 22 of the flexible membrane 2 in a state tightly pressing against and sealing the end face 12 of the tubular member 1. Flow of the fluid in the reverse direction and leakage resulting from excessive fluid pressure are avoided. The sealing reliability and prevention of reverse flow are enhanced.

Referring to FIG. 5, when the fluid flows from the inlet pipe 41 toward the outlet pipe 42 (forward flow), the sealing circumference 22 of the flexible membrane 2 is pushed away from the end face 12 of the tubular member 1 by the fluid. The sealing circumference 22 of the flexible membrane 2 bends toward the outlet 31, providing a fluid passageway allowing the fluid from the inlet pipe 41 to enter the outlet pipe 42 after passing through the inlet 102, the valve port 101, and the outlet 31 of the cap 3. When the flexible membrane 2 is in the bent, open state, the positioning portion 21 of the flexible membrane 2 is still securely sandwiched between the positioning rod 13 of the tubular member 1 and the positioning rod 32 of the cap 3 without the risk of undesired displacement. The positioning reliability of the flexible membrane 2 is improved.

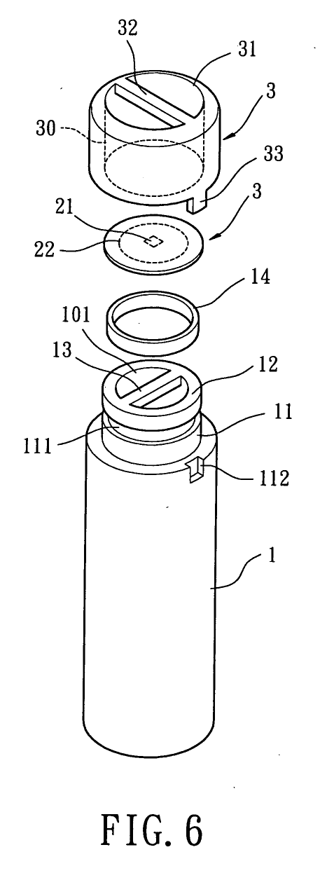

FIG. 6 illustrates a second embodiment of the check valve in accordance with the present invention, wherein the positioning rod 32 of the cap 3 extends in a direction orthogonal to the positioning rod 13 of the tubular member 1. Further, the positioning portion 21 of the flexible membrane 2 is in the center of the flexible membrane 2. In other words, the positioning portion 21 of the flexible membrane 2 is sandwiched by a central portion of the positioning rod 13 of the tubular member 1 and a central portion of the positioning rod 32 of the cap 3. Operation of the flexible membrane 2 is similar to that in the first embodiment. When fluid flows in a counter direction, the flexible membrane 2 seals the valve port 101 and the sealing circumference 22 of the flexible membrane 2 is supported by the end face 12 of the tubular member 1. When the fluid flows in a forward direction, the flexible membrane 2 is bent to allow the fluid to flow from the inlet 102 to the outlet 31. Thus, the check valve of the second embodiment also provides improved sealing reliability, improved positioning reliability, simplified structure, and easy, rapid assembling as well as flexible design choices for compact check valves.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A check valve for fluid, the check valve comprising:
a tubular member including a coupling section and an inlet, the coupling section of the tubular member including a valve portion, an end face, and a positioning rod;
a cap including a coupling section for coupling with the coupling section of the tubular member, the cap further including an outlet aligned with the valve port, a positioning rod being provided on the outlet of the cap; and
a flexible membrane including a positioning portion securely sandwiched between the positioning rod of the tubular member and the positioning rod of the cap, the flexible membrane further including a sealing circumference;
wherein when fluid flows in a reverse direction, the flexible membrane sealing the valve port, with the sealing circumference of the flexible membrane being supported by the end face of the tubular member; and
wherein when the fluid flows in a forward direction, the flexible membrane is bent to allow the fluid to flow from the inlet to the outlet.

2. The check valve for fluid as claimed in claim 1, wherein diameters of the coupling section and the outlet of the cap are greater than that of the valve port of the tubular member, and wherein the end face of the tubular member is located inside the coupling section of the cap.

3. The check valve for fluid as claimed in claim 1, wherein the positioning rod of the tubular member extends across the valve port, the positioning rod of the cap extending across the outlet and aligned with the positioning rod of the tubular member for sandwiching the positioning portion of the flexible membrane.

4. The check valve for fluid as claimed in claim 1, wherein the positioning rod of the tubular member extends across the valve port, the positioning rod of the cap extending across the outlet and extending in a direction orthogonal to the positioning rod of the tubular member for sandwiching the positioning portion in a center of the flexible membrane.

5. The check valve for fluid as claimed in claim 1, wherein the coupling section of the tubular member is a stepped portion for coupling with the coupling section of the cap.

6. The check valve for fluid as claimed in claim 5, wherein the coupling section of the tubular member comprises an annular groove, further comprising a sealing washer mounted in the annular groove for preventing leakage between the coupling section of the tubular member and the coupling section of the cap.

7. The check valve for fluid as claimed in claim 5, wherein the coupling section of the tubular member comprises an engaging portion and the coupling section of the cap comprises an engaging portion for engaging with the engaging portion of the tubular member while locating the positioning rod of the cap relative to the positioning rod of the tubular member.

8. The check valve for fluid as claimed in claim 7, wherein one of the engaging portions is a protrusion and the other of the engaging portions is a recession.
